(19) United States
(12) Patent Application Publication
(10) Pub. No.: US 2025/0293616 A1
(43) Pub. Date: Sep. 18, 2025

(54) MULTI-OBJECTIVE DESIGN OPTIMIZATION METHOD FOR AUXILIARY RESONANT COMMUTATED POLE INVERTER

(71) Applicant: Deere & Company, Moline, IL (US)

(72) Inventors: Nan LIN, Fargo, ND (US); Brij N. SINGH, West Fargo, ND (US); Yuheng WU, Fargo, ND (US); Zachary WEHRI, Fargo, ND (US); Long WU, Fargo, ND (US)

(73) Assignee: Deere & Company, Moline, IL (US)

(21) Appl. No.: 19/021,933

(22) Filed: Jan. 15, 2025

Related U.S. Application Data
(60) Provisional application No. 63/565,328, filed on Mar. 14, 2024.

(51) Int. Cl. H02M 7/48; G06F 30/20; G06F 111/06

(52) U.S. Cl. CPC H02M 7/4818; G06F 30/20; G06F 2111/06

(57) ABSTRACT

A method for optimizing an inverter for soft switching according to at least some example embodiments includes calculating efficiency values of the inverter based on a plurality of possible resonant inductance values and a plurality of possible resonant capacitance values, calculating change of voltage over time values of the inverter based on the plurality of possible resonant inductance values and the plurality of possible resonant capacitance values, and selecting a resonant inductance value of the plurality of possible resonant inductance values and a resonant capacitance value of the plurality of possible resonant capacitance values based on the calculated efficiency values of the inverter and the calculated change of voltage over time values.

### CROSS-REFERENCE TO RELATED APPLICATIONS

This application claims priority under 35 U.S.C. § 119 (e) to U.S. Provisional Appln. No. 63/565,328 filed on Mar. 14, 2024, the entire contents of which are hereby incorporated by reference.

### GOVERNMENT LICENSE RIGHTS

This invention was made with government support under DE-EE0009874 awarded by United States Department of Energy. The government has certain rights in the invention.

### SUMMARY

Some example embodiments provide systems and methods for multi-objective design optimization for an auxiliary resonant commutated pole inverter.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a schematic of an electric drive system according to an example embodiment.

FIG. 2 illustrates an equivalent circuit of the inverter shown in FIG. 1.

FIG. 3A illustrates one phase-leg of the inverter shown in FIG. 2.

FIG. 3B is an operation waveform for one switching cycle of the one phase-leg shown in FIG. 4A.

FIG. 3C illustrates a diagram of variable timing control according to example embodiments.

FIG. 4 is a flow chart illustrating a method according to example embodiments.

FIG. 5 is an operation waveform illustrating design parameters of an inverter according to example embodiments.

FIG. 6A illustrates an equivalent circuit of a resonance period between t6 and t7 of FIG. 3B according to example embodiments.

FIG. 6B illustrates an equivalent circuit of a resonance period between t1 and t2 of FIG. 3B according to example embodiments.

FIGS. 7A and 7B illustrate polyfit functions according to example embodiments.

FIG. 8 is a flow chart illustrating a method according to example embodiments.

FIG. 9 is an example of inverter efficiency of an inverter according to example embodiments.

### DETAILED DESCRIPTION

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

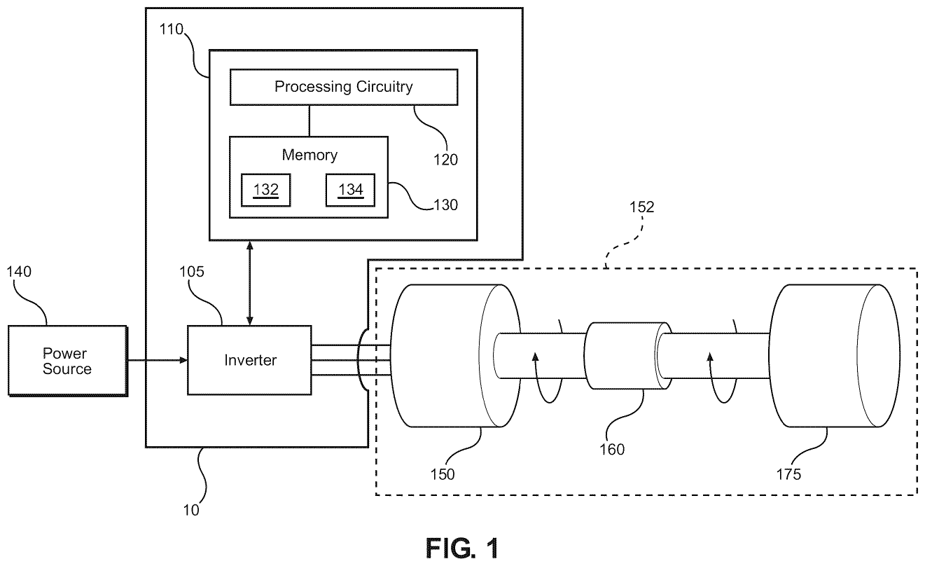

FIG. 1 illustrates a schematic of an electric drive system according to an example embodiment.

As shown in FIG. 1, an electric drive 10 includes an inverter 105 and a controller 110 to generate commands (e.g., voltage and/or current commands) for an electric machine 150 (e.g., a motor). The electric machine 150 is part of a modeled electro-mechanical system 152. In addition to the electric machine 150, the modeled electro-mechanical system 152 includes a mechanical load 175 and a coupler 160. The electric machine 150 is coupled to the mechanical load 175 though the coupler 160 (e.g., a compliant coupler modelled by stiffness and damping properties). The coupler 160 comprises a mechanical, rotational coupler, such as a flexible coupler, a bellows coupler, a flexible joint, a universal joint, a flange coupler, a gearbox, or a transmission, for example. The electric machine 150 is configured to drive the mechanical load 175 based on the commands provided to the electric machine 150 from the controller 110. A power source 140 provides power to the inverter 105. For example, the power source 140 may provide DC power to the inverter 105. For example, the power source 140 may be a battery. The inverter 105 may convert DC input into AC current to drive the motor 150.

In some example embodiments, the controller 110 includes processing circuitry 120 and memory 130. The controller 110 is configured to perform the methods and algorithms described herein. In some example embodiments, the processing circuitry 120 is configured to execute instructions stored in the memory 130 to cause the electric drive 10 to perform the methods and algorithms described herein. In some example embodiments, the controller 110 may be electrically connected to the inverter as shown in FIG. 1. However, example embodiments are not limited thereto and in some example embodiments the controller 110 may implement a simulation of the inverter 105.

The term ‘processing circuitry,’ as used in the present disclosure, may refer to, for example, hardware including logic circuits; a hardware/software combination such as a processor executing software; or a combination thereof. For example, the hardware more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

According to some example embodiments, the memory 130 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

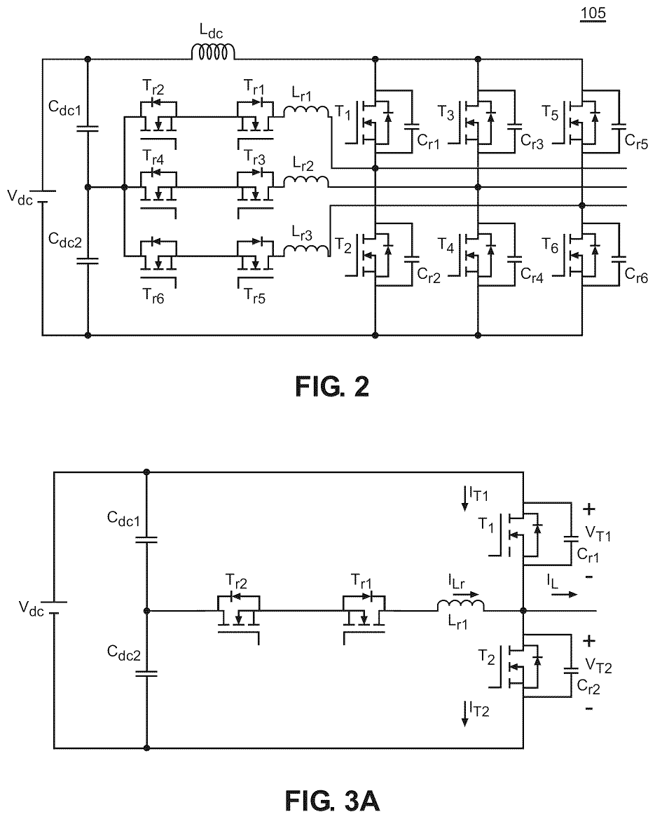

FIG. 2 illustrates an equivalent circuit of the inverter shown in FIG. 1.

Referring to FIG. 2, inverter 105 may include first capacitors C_{dc1}-C_{dc2}, second capacitors Cᵣ₁-Cᵣ₆, first switches T₁-T₆, second switches Tᵣ₁-T_{R6}, inductors Lᵣ₁-Lᵣ₃ and/or inductor L_{dc}. The inverter 105 may receive an input voltage V_{dc} from, for example, the power source 140 and may output an output voltage V_{dc} to, for example, the electric machine 150. The first switches T₁-T₆ may be referred to herein as main switches and the second switches Tᵣ₁-T_{R6} may be referred to herein as auxiliary switches. The first switches T₁-T₆ and the second switches Tᵣ₁-Tᵣ₆ may be switching semiconductors (e.g., insulated gate bipolar transistors (IGBT), silicon carbide (SiC) metal-oxide-semiconductor field effect transistors (MOSFET5), or other power transistors). The first switches T₁-T₆ may be turned on under zero voltage switching (ZVS). Auxiliary switches Tᵣ₁-Tᵣ₆ may realize zero current switching (ZCS) during turn-off periods. The first capacitors C_{dc1}-C_{dc2} may be referred to herein as main capacitors and the second capacitors Cᵣ₁-Cᵣ₆ may be referred to herein as resonant capacitors. The inductors Lᵣ₁-Lᵣ₃ may be referred to as resonant inductors and may be variable inductors.

According to some example embodiments, the inverter 105 may be an auxiliary resonant commutated pole (ARCP) inverter.

As shown in FIG. 2, a first terminal of the first capacitor C_{dc1} is connected to a first terminal of inductor L_{dc}. A second terminal of inductor Lac is connected to a drain of first switches T₁, T₃, and T₅. A first terminal of the first capacitor C_{dc2} is connected to a source of first switches T₂, T₄, and T₆. A second terminal of capacitor C_{dc1} is connected to a second terminal of first capacitor C_{dc2} and to drains of second switches Tᵣ₂, Tᵣ₄, and Tᵣ₆. Sources of second switches Tᵣ₂, Tᵣ₄, and Tᵣ₆ are connected, respectively, to sources of second switches Tᵣ₁, Tᵣ₃, and Tᵣ₅. Drains of second switches Tᵣ₁, Tᵣ₃, and Tᵣ₅ are connected, respectively, to first terminals of inductors Lᵣ₁, Lᵣ₂, and Lᵣ₃. A second terminal of inductor Lᵣ₁ is connected to a source of first switch T₁ and a drain of second switch T₂. A second terminal of inductor Lᵣ₂ is connected to a source of first switch T₃ and a drain of first switch T₄. A second terminal of inductor Lᵣ₃ is connected to a source of first switch T₅ and a drain of first switch T₆. Each of first switches T₁-T₆ is connected in parallel to a respective second capacitor Cᵣ₁-Cᵣ₆. For example, a first terminal of each second capacitor Cᵣ₁-Cᵣ₆ is connected to a source of a respective first switch T₁-T₆ and a second terminal of each second capacitor Cᵣ₁-Cᵣ₆ is connected to a drain of the respective first switch T₁-T₆. Thus, a resonant capacitor Cᵣ is connected in parallel to each main switch T while a resonant inductor Lᵣ is connected between the auxiliary switches Tᵣ and a middle point in each phase of the inverter 105.

The controller 110 may control the first switches T₁-T₆ and the second switches Tᵣ₁-Tᵣ₆ to provide soft switching in which voltage and current waveforms of the switches do not overlap with each other, so that the switching energy is reduced, as described in R. W. De Doncker and J. P. Lyons, “The auxiliary resonant commutated pole converter,” Conference Record of the 1990 IEEE Industry Applications Society Annual Meeting, Seattle, WA, USA, 1990, pp. 1228-1235 vol. 2 and Bijlenga et al. “ARCP CONVERTER AND A METHOD FOR CONTROL THEREOF.” U.S. Patent US 2004/0246756A1, Dec. 9, 2004, which are herein incorporated by reference in its entirety.

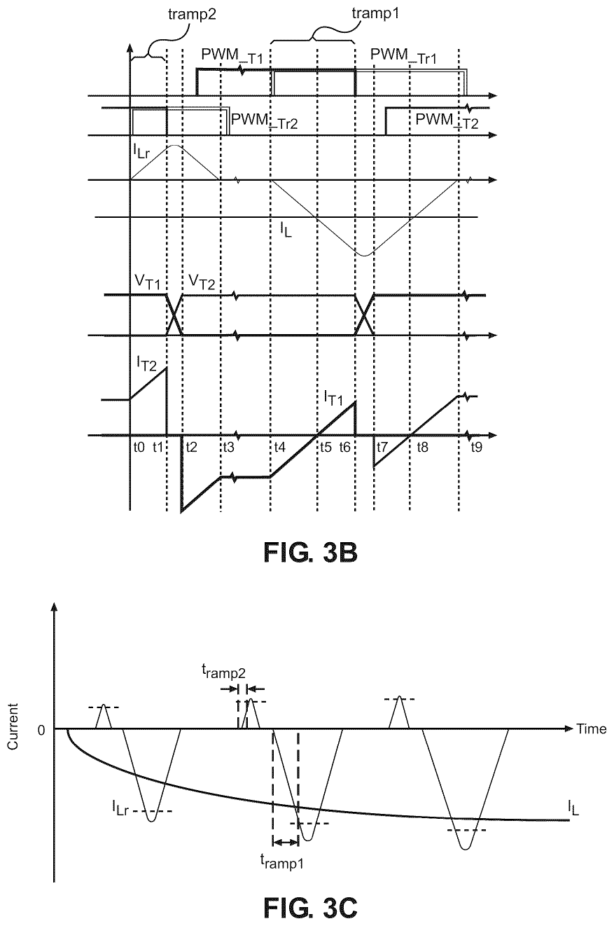

FIG. 3A illustrates one phase leg of the inverter 105.

FIG. 3B is an operation waveform for one switching cycle of the one phase-leg of the inverter 105 shown in FIG. 3A.

FIG. 3C illustrates a diagram of variable timing control according to example embodiments.

Referring to FIGS. 3A to 3C, the top two rows of FIG. 3B show pulse-width modulation (PWM) signals PWM_{T1}, PWM_{T2}, PWM_{Tr1}, and PWM_{Tr2} of main switches T₁ and T₂ and auxiliary switches Tᵣ₁ and Tᵣ₂, respectively. The middle rows of FIG. 3B show a load current I_{L} and an inductor current I_{Lr} through the resonant inductor Lᵣ₁. The bottom two rows of FIG. 3B show voltage waveforms V_{T1} and V_{T2} and current waveforms I_{T1} and I_{T2} of the main switches T₁ and T₂, respectively.

As shown in FIG. 3B, a switching cycle may include two resonant inductor current pulses with different amplitudes. A resonance period occurs during the periods when the absolute value of the inductor current I_{Lr} is higher than the dashed lines shown in FIG. 3C.

The time during which the resonant inductor Lᵣ₁ current ramps up before the resonance period is denoted in FIGS. 3B and 3C as first and second ramp periods tᵣₐₘₚ₁ and tᵣₐₘₚ₂. The ramp period tᵣₐₘₚ for the inductor current I_{Lr} pulse with higher amplitude in a switching cycle is denoted as a first ramp period tᵣₐₘₚ₁ while the ramp period tᵣₐₘₚ for the inductor current I_{L} pulse with a lower amplitude in a switching cycle is denoted as a second ramp period tᵣₐₘₚ₂.

First ramp period tᵣₐₘₚ₁ and second ramp period tᵣₐₘₚ₂ are also the periods during which a main switch T₁ or T₂, and its corresponding auxiliary switch Tᵣ₁ or Tᵣ₂ are turned on at the same time, as shown in FIG. 3B. The first and second ramp periods tᵣₐₘₚ₁ and tᵣₐₘₚ₂ determine the amplitude of inductor current I_{Lr} pulses, which further affect the following resonances of the circuit. Variable timing control may be achieved, according to example embodiments, by regulating first and second ramp periods tᵣₐₘₚ₁ and tᵣₐₘₚ₂ according to the load current I_{L}.

A design method according to example embodiments may achieve soft switching in the inverter 105.

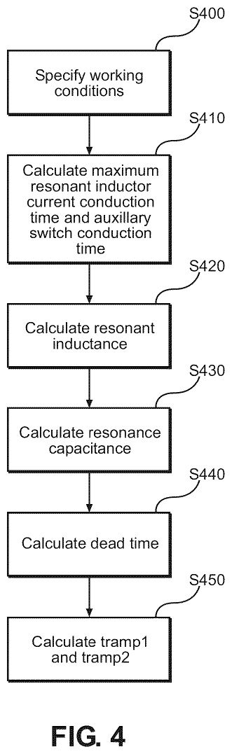

FIG. 4 is a flow chart illustrating a general design method according to example embodiments. The method shown in FIG. 4 may be performed at the controller 110.

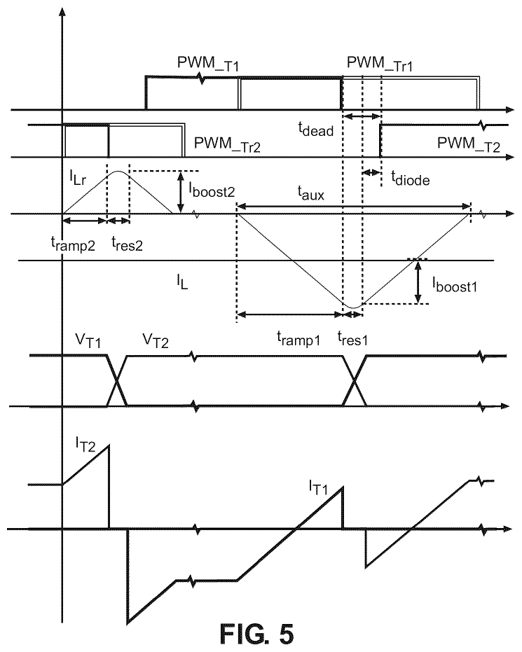

FIG. 5 is an operation waveform illustrating design parameters of the inverter 105.

Referring to FIG. 4, at S400 the controller 110 specifies working conditions of the inverter 105 according to load and power device characteristics. For example, the controller 110 may determine parameters indicating the working conditions of the inverter 105 including a DC bus voltage V_{DC}, a switching frequency fsw, a modulation index MI, and/or a rated output power Pₒᵤₜ. A peak phase current I_{phase_peak} may be calculated based on the rated output power Pₒᵤₜ and the load. A maximum resonance time t_{res_max} may be determined according to a desired change of voltage over time dV/dt.

The controller 110 may determine the working conditions of the inverter 105 according to any known method. For example, the controller 110 may determine working conditions of the inverter 105 according to a look-up table. An example of parameters for a 10-kW design are shown in Table 1.

TABLE 1

| Parameters | Values |
|---|---|
| V_{dc} | 700 V |
| fsw | 500 kHz |
| MI | 0.79 |
| Pₒᵤₜ | 10 kW |
| Iₚₕₐₛₑ_{_{—}}ₚₑₐₖ | 45 A |
| Tᵣₑₛ_{_{—}}ₘₐₓ | 250 ns |

Returning to FIG. 4, at S410 the controller 110 calculates a maximum resonant inductor current conduction time t_{aux_max} and an auxiliary switch conduction time t_{aux_sw}. The maximum resonant inductor current conduction time t_{aux_max} is determined to be smaller than a minimum pulse width of main switch gate signals t_{pulse_min}. Using the maximum resonant inductor current conduction time t_{aux_max} smaller than the minimum pulse width of main switch gate signals t_{pulse_min} may ensure that auxiliary switches Tᵣ are turned off before the next corresponding main switches T are turned on. Typically, the maximum resonant inductor current conduction time t_{aux_max} value should be much smaller than the switching period to reduce or minimize the effect of the resonance circuit. The minimum pulse width of main switch gate signals t_{pulse_min} may be determined according to Equation 1.

$${t}_{pulse \_ min} = \frac{1 - MI}{2 {f}_{S W}} \qquad Equation 1$$

At S420 the controller 110 calculates a resonant inductance Lᵣ. The value of the resonant inductance Lᵣ may be determined based on a maximum ramp value t_{ramp_max}. The maximum ramp value t_{ramp_max} may be a maximum value of first and second ramp periods tᵣₐₘₚ₁ and tᵣₐₘₚ₂, which is related (e.g., directly related) to the maximum value of inductor current I_{Lr} and further affects resonant behavior. The maximum ramp value t_{ramp_max} is used to determine an inductance value for an inductor Lᵣ to provide the maximum resonant current. The maximum ramp value t_{ramp_max} may be calculated according to Equation 2. The inductance value for the inductor Lᵣ may be further calculated according to Equation 3.

Referring to FIG. 5, a first boost current I_{boost1} indicates a difference between load current I_{L} and inductor current I_{Lr} at the beginning of the resonance period of the inductor current I_{Lr} pulse. A second boost current I_{boost2} is the value of inductor current I_{Lr} at the beginning of the resonance of the other inductor current I_{Lr} pulse. First and second boost currents I_{boost1} and I_{boost2} are related (e.g., directly related) to the resonance energy needed for soft switching. First and second boost currents I_{boost1} and I_{boost2} should be large enough to provide enough resonance energy, but small enough to limit the inductor current I_{Lr} peak value. In some example embodiments, the first and second boost currents I_{boost1} and I_{boost2} may be set equal each other. For example, first and second boost currents I_{boost1} and I_{boost2} may be set to equal 10 A.

However, example embodiments are not limited thereto. When first and second boost currents I_{boost1} and I_{boost2} are set to be equal, they may be referred to collectively as boost current I_{boost}.

$${t}_{ramp \_ max} = \frac{{t}_{aux \_ max} - {t}_{res \_ max}}{2} \qquad Equation 2$$

$${L}_{r} = \frac{\frac{{V}_{d c}}{2} {t}_{ramp \_ max}}{{I}_{b o o s t} + {I}_{phase \_ peak}} \qquad Equation 3$$

Returning to FIG. 4, at S430 the controller 110 calculates a resonance capacitance Cᵣ. The

$${Z}_{0} = \sqrt{\frac{{L}_{r}}{2 {C}_{r}}} and {w}_{0} = \frac{1}{\sqrt{2 {L}_{r} {C}_{r}}} .$$

resonance capacitance Cᵣ may be calculated according to Equation 4, where

$${t}_{res\_max} = \frac{2}{{w}_{0}} {tan}^{- 1} \frac{{V}_{dc}}{2 {Z}_{0} {I}_{boost}} \qquad \underline{Equation 4}$$

At S440 the controller 110 calculates a dead time t_{dead}. The dead time t_{dead} may be a key parameter to be calculated for soft switching. The dead time t_{dead} should be longer than the resonance time for ZVS of the main switches T. However, if the dead time t_{dead} is too long, the ZVS may fail. Referring to FIG. 3B, the PWM signal PWM__{T2} should be enabled between t7 and t8 when there is negative current through main switch T2. The period between t7 and t8 may be denoted as a diode time t_{diode} and may be calculated according to Equation 5.

$${t}_{diode} = \frac{{I}_{boost} {L}_{r}}{\frac{{V}_{dc}}{2}} \qquad \underline{Equation 5}$$

If the dead time t_{dead} is longer than the period between t6 and t8, main switch T₂ will lose ZVS because its current becomes positive after t8. Therefore, there is an upper limit for the dead time t_{dead} to ensure ZVS of main switch T₂. The resonance time before main switch T₂ is turned on may be denoted as first resonance time tᵣₑₛ₁ and may be calculated according to Equation 6.

$${t}_{res 1} = \frac{2}{{w}_{0}} {tan}^{- 1} \frac{{V}_{dc}}{2 {Z}_{0} {I}_{boost 1}} \qquad \underline{Equation 6}$$

The dead time t_{dead} before main switch T₂ turns on may be calculated according to Equation 7.

$${t}_{res 1} < {t}_{dead} < {t}_{res 1} + {t}_{diode} \qquad \underline{Equation 7}$$

For the turn-on event of main switch T₁, since the main switch current I_{T1} is negative except for a short period before turn-off, there is no upper limit for the dead time t_{dead}. The lower limit of the dead time t_{dead} should be longer than a second resonance period tᵣₑₛ₂ during which the resonant inductor current I_{Lr} through the resonant inductor Lᵣ₁ is at a maximum. The dead time t_{dead} before turn-on of main switch T₁ may be set according to Equation 8 and the second resonance period tᵣₑₛ₂ may be calculated according to Equation 9.

$${t}_{dead} > {t}_{res 2} \qquad \underline{Equation 8}$$

$${t}_{res 2} = \frac{2}{{w}_{0}} {tan}^{- 1} \frac{{V}_{dc}}{2 {Z}_{0} {I}_{boost 2}} \qquad \underline{Equation 9}$$

Returning to FIG. 4, at S450 the controller 110 determines first and second ramp periods tᵣₐₘₚ₁ and tᵣₐₘₚ₂ according to the load current I_{L}. According to example embodiments, for variable timing control of the inverter 105, first ramp period tᵣₐₘₚ₁ and/or second ramp period tᵣₐₘₚ₂ may be regulated according to the load current I_{L} to reduce or minimize the resonant inductor current I_{Lr} through the resonant inductor Lᵣ₁. Accordingly, the controller 110 determines a relationship between first ramp period tᵣₐₘₚ₁ and second ramp period tᵣₐₘₚ₂ and the load current I_{L} which will be used to control the inverter 105.

First and second ramp periods tᵣₐₘₚ₁ and tᵣₐₘₚ₂ are related to first and second boost currents I_{boost1} and I_{boost2}, which directly contribute to amplitudes of the two resonant inductor current I_{Lr} pulses shown in FIG. 5. For example, tᵣₐₘₚ₁ may be directly related to I_{boost1}, as expressed by Equation 14 and tᵣₐₘₚ₂ may be directly related to I_{boost2} as expressed by Equation 15. Therefore, current stress may be reduced by reducing or minimizing first boost current I_{boost1} and/or second boost current I_{boost2}.

First and second boost currents I_{boost1} and I_{boost2} may affect the energy available for their corresponding resonance period. For example, the energy available for a first resonance period is equal to ½ *Lᵣ*I_{boost1_min}² and the energy for a second resonance period is ½ *Lᵣ*I_{boost2_min}². Thus, the energy available is directly related to I_{boost1_min} and I_{boost2_min}.

In real circuits, there is generally some loop resistance caused by various reasons, such as on-state drain-to-source resistance of power devices. The minimum first boost current I_{boost1} and second boost current I_{boost2} provide enough resonance energy to compensate for energy dissipation caused by the loop resistance.

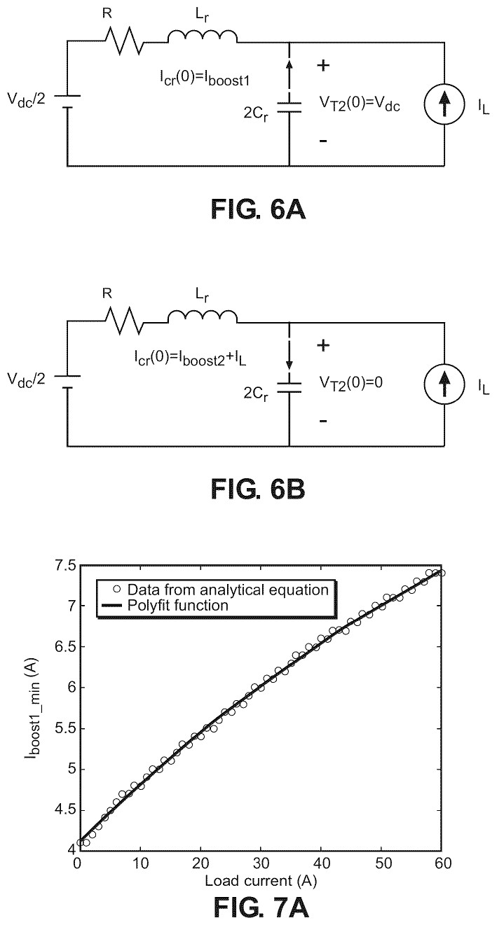

FIG. 6A illustrates an equivalent circuit of a resonance period between t6 and t7 of FIG. 3B according to example embodiments.

FIG. 6B illustrates an equivalent circuit of a resonance period between t1 and t2 of FIG. 3B according to example embodiments.

Referring to FIGS. 2, 6A, and 6B, the two resonant capacitors Cᵣ of top and bottom switches T₁ and T₂ (e.g., resonant capacitors Cᵣ₁ and Cᵣ₂ of switches T₁ and T₂, respectively) are equivalent to being in parallel during the resonance periods (e.g., between t1 and t2 and between t6 and t7). For simplicity, only equivalent loop resistance R, resonance inductance Lᵣ equivalent resonance capacitance 2Cᵣ, and power source V_{dc}/2 are shown in FIGS. 6A and 6B. Since the behavior of the top loop (C_{dc1}-Tᵣ₂-Tᵣ₁-Lᵣ₁-T₁) in FIG. 3A is symmetrical to the bottom loop (C_{dc2}-Tᵣ₂-Tᵣ₁-Lᵣ₁-T₂), these two loops are regarded as being in parallel. The resonance capacitance 2Cᵣ is therefore shown in FIGS. 6A and 6B. Since switch T₂ is in parallel with resonant capacitor Cᵣ₂ in FIG. 3A, the voltage across the resonance capacitance 2Cᵣ is the voltage of switch T₂.

A voltage of bottom switch V_{T2} (e.g., the voltage across the resonance capacitance 2Cᵣ), as shown in FIG. 6A can be expressed according to Equation 10, where

$$β = \frac{1}{2} \sqrt{\frac{2}{{L}_{r} {C}_{r}} - {( \frac{R}{{L}_{r}} )}^{2}} .$$

$${V}_{T 2} = {e}^{- \frac{R}{2 {L}_{r}} t} ( ( - {RI}_{L} + \frac{1}{2} {V}_{dc} ) cos β t ++ \frac{1}{2 {C}_{r} β} ( - {I}_{boost 1} + \frac{{RC}_{r}}{{L}_{r}} ( - {RI}_{L} + \frac{1}{2} {V}_{dc} ) ) sin βt ) + \frac{1}{2} {V}_{dc} + {RI}_{L} \qquad \underline{Equation 10}$$

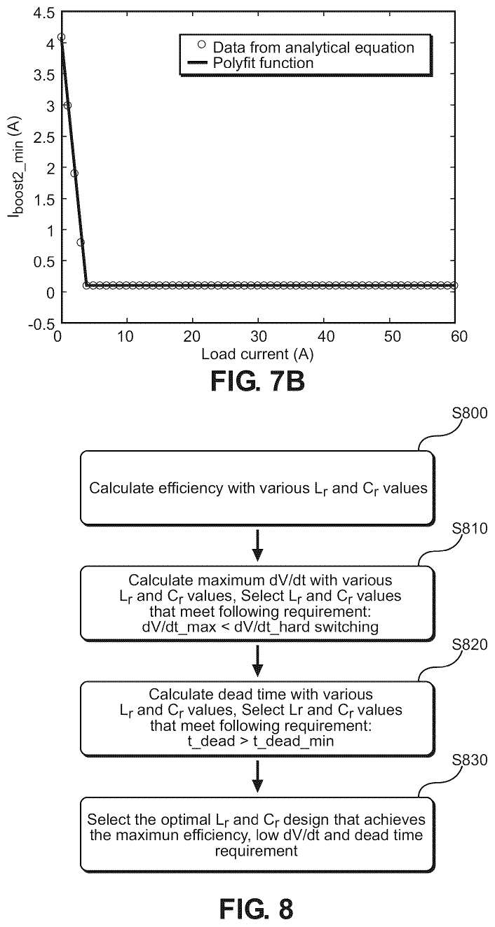

The main switch voltage V_{T2} may be decreased to 0 V during the resonance period between t6 and t7, so the switch T₂ can be zero voltage turned on, as shown in FIG. 3B. For example, the minimum value of main switch voltage V_{T2} in Equation 10 may be less than zero. Since first boost current I_{boost1} in Equation 10 is controlled by first ramp period tᵣₐₘₚ₁ and a minimized first boost current I_{boost1} is desired to reduce loss, the relationship between the minimum value of first boost current I_{boost1}, (e.g., minimum first boost current I_{boost1_min}), and load current I_{L} can be derived from the ZVS condition of Equation 10 described above. However, a function describing the relationship between the minimum value of first boost current I_{boost1}, and load current I_{L} may be too complex to be expressed analytically. Therefore, this function may be derived by a polyfit function. An example polyfit function is shown in FIG. 7A.

Referring to FIG. 7A, the circles shown represent minimum first boost current I_{boost1_min} values obtained from Equation 10 when minimum main switch voltage V_{T2} is equal to 0. The curve shown in FIG. 7A represents the polyfit function for those discrete values. A polyfit function such as the example shown in FIG. 7A may be used to regulate first boost current I_{boost1} at different load currents I_{L}, according to example embodiments. The polyfit function shown in FIG. 7A may be expressed as Equation 11.

$${I}_{boost {1}_{-} min} = - 0.0 \; 0028 {I}_{L}^{2} + 0.0 \; 72 {I}_{L} + 4.12 \qquad \underline{Equation 11}$$

For the resonance period between t1 and t2 (e.g., shown in FIG. 6B), the main switch voltage V_{T2} may be expressed according to equation 12.

$${V}_{T 2} = {e}^{- \frac{R}{2 {L}_{r}} t} ( - ( {RI}_{L} + \frac{1}{2} {V}_{dc} ) cos β t ++ \frac{1}{2 {C}_{r} β} ( ( {I}_{boost 2} + {I}_{L} ) - \frac{{RC}_{r}}{{L}_{r}} ( {RI}_{L} + \frac{1}{2} {V}_{dc} ) ) sin βt ) + \frac{1}{2} {V}_{dc} + {RI}_{L} \qquad \underline{Equation 12}$$

The main switch voltage V_{T2} may be increased to DC bus voltage V_{dc} during the resonance period between t1 and t2 so that the top main switch T₁ can be turned on with ZVS between t1 and t2 and afterwards, as shown in FIG. 3B. The minimum second boost current I_{boost2} values, I_{boost2_min}, and the associated polyfit function are shown in FIG. 7B. The polyfit function shown in FIG. 7B may be expressed as Equation 13.

$${l}_{boost 2 \_ min} = \{ \begin{matrix}- 1.02 {I}_{L} + \text{.402} & ( {I}_{L} < 4 ) \\ 0 & ( {I}_{L} \geq 4 )\end{matrix} \qquad \underline{Equation 13}$$

The first and second ramp periods tᵣₐₘₚ₁ and tᵣₐₘₚ₂ can be calculated separately according to Equation 14 and Equation 15, respectively.

$${t}_{ramp 1} = \frac{{L}_{r} ( {I}_{boost 1} + {I}_{Phase\_peak} )}{\frac{{V}_{dc}}{2}} \qquad \underline{Equation 14}$$

$${t}_{ramp 2} = \frac{{L}_{r} {I}_{boost 2}}{\frac{{V}_{dc}}{2}} \qquad \underline{Equation 15}$$

Minimum values of first ramp period tᵣₐₘₚ₁ and/or second ramp period tᵣₐₘₚ₂ may therefore be calculated using Equation 11 and Equation 13 together with Equation 14 and Equation 15. By controlling the first and second ramp periods tᵣₐₘₚ₁ and tᵣₐₘₚ₂ using Equations 11 to 15, according to example embodiments, current stress and/or current loss may be reduced or minimized on auxiliary switches Tᵣ and/or resonant inductors Lᵣ while maintaining soft switching functionality in inverter 105.

The method discussed above with regard to FIG. 4 may achieve soft switching in the inverter 105 with reduced or minimized resonant inductor current ILᵣ. However, the above discussed method may not provide for an analysis of the performance of the inverter 105 based on many or all possible design parameter combinations. For example, a lower change in voltage over time dV/dt may be a benefit of the inverter 105 compared to a conventional hard switching inverter that may not be achieved by the method of FIG. 4.

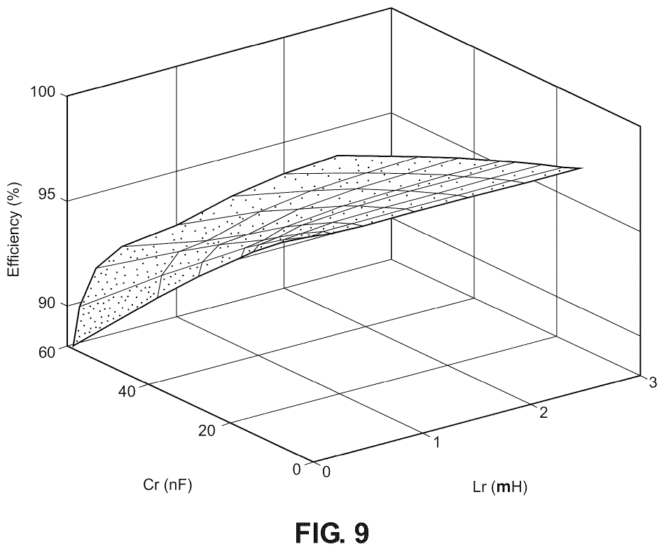

FIG. 8 is a flow chart illustrating a method according to example embodiments. The method shown in FIG. 8 may be performed at the controller 110.

Referring to FIGS. 2 and 8, at S800 the controller 110 calculates an efficiency of the inverter 105 using various resonant inductance Lᵣ and resonant capacitance Cᵣ values for the inductors L₁-L₃ and the second capacitors Cᵣ₁-Cᵣ₆. For example, the controller 110 may calculate the efficiency of the inverter 105 for each switch of the first switches T₁-T₆ and/or the second switches Tᵣ₁-Tᵣ₆. The controller 110 may calculate the efficiency of the inverter 105 for a particular switch as a function of a DC bus voltage V_{dc} of inverter 105 (e.g., an inverter voltage), a DC bus current flowing through the inverter 105 (e.g., an inverter current) I_{dc}, a voltage (e.g., a time varying voltage) at the first switches T₁-T₆ (e.g., a switch voltage) V_{switch}, a current (e.g., a time varying current) at the first switches T₁-T₆ (e.g., a switch current) I_{swtich}, a turn-on time of the respective switch t_{switch_on_trans}, a turn-off time of the respective switch t_{switch_off_trans}, a SiC die temperature of the inverter 105 switches, and/or a number of switches in the circuit. The inverter voltage may be expressed as a waveform with varying value between 0V to V_{dc}. The inverter current may be expressed as a waveform with varying value between OA to I_{dc}. The turn-on time and turn-off times may be considered individually for each switch as a function of a SiC die temperature of the respective switch.

FIG. 9 is an example of inverter efficiency of inverter 105 for various L, and Cᵣ values based on the hardware parameters for a 10 kW design according to Table 1.

Referring to FIG. 9, the efficiency of the inverter 105 increases when both values of resonant inductance Lᵣ and resonant capacitance Cᵣ decrease. While high efficiency may be desired, the maximum efficiency as shown in FIG. 9 may not be the global optimized design if other optimization targets and constraints are considered. For example, a determined maximum efficiency may be different when a change of voltage over time dV/dt is considered as a second optimization target. For example, a maximum change in voltage over time dV/dt of inverter 105 dV/dt_{ARCP_max} should be smaller than the typical value of hard switching inverter dV/dt_{hardswitching}, as expressed by Equation 16, so that a possible electromagnetic interference (EMI) issue caused by fast switching speed in a hard switching inverter could be attenuated in the inverter 105 using soft switching.

$$dV / {dt}_{\_ARCP \_max} < dV / {dt}_{\_hardswitching} \qquad \underline{Equation 16}$$

At S810, the controller 110 calculates a maximum change of voltage over time (dV/dt) of the inverter 105 using the various resonant inductance Lᵣ and resonant capacitance Cᵣ values for the inductors Lᵣ₁-Lᵣ₃ and the second capacitors Cᵣ₁-Cᵣ₆. For example, the controller 110 may calculate the maximum change of voltage over time dV/dt for each switch of the first switches T₁-T₆. The controller 110 may calculate the maximum change of voltage over time dV/dt for a particular switch as a function of an operating voltage of a switch-on operation of the respective switch V_{switch_on}, an operating voltage of a switch-off operation of the respective switch V_{switch_off}, a turn-on time of the respective switch t_{switch_on_trans}, and/or a turn-off time of the respective switch t_{switch_off_trans}. The operating voltage of the switch-on operation of a switch V_{switch_on} may be determined according to the equation V_{switch_on}=V_{dc}/t_{switch_on_trans}, and/or a SiC die temperature of the inverter 105 switches. The operating voltage of the switch-off operation of a switch V_{switch_off} may be determined according to the equation V_{switch_off}=V_{dc}+L_{dc}(I_{dc}/t_{switch_off_trans}), where L_{dc} is a stray parameter indicating a bus inductance of the inverter 105.

The controller 110 may select resonant inductance values Lᵣ and resonant capacitance values Cᵣ that result in a maximum change of voltage over time dV/dt_{ARCP_max} that is less than a threshold voltage over time of the inverter 105 calculated according to hard switching (e.g., switching performed by only the first switches T₁-T₆).

For example, the controller may calculate the maximum change of voltage over time of inverter 105 dV/dt_{ARCP_max} using Equation 6, Equation 9, and Equation 17.

$$dV / {dt}_{ARCP\_max} = \frac{{V}_{dc}}{{t}_{res\_min}} \qquad \underline{Equation 17}$$

At S820, the controller 110 calculates a dead time t_{dead} of the inverter 105 using various resonant inductance Lᵣ and resonant capacitance Cᵣ values for the inductors Lᵣ₁-Lᵣ₃ and the second capacitors Cᵣ₁-Cᵣ₆. The dead time t_{dead} is a variable that relates to soft switching performance of the inverter 105. For example, the dead time t_{dead} may indicate a waiting time between an on/off operation of two complementary switches. Two switches that are connected serially may be referred to herein as complementary. For example, referring to FIG. 2, first switches T₁ and T₂ are complementary, first switches T₃ and T₄ are complementary, first switches T₅ and T₆ are complementary, second switches Tᵣ₁ and Tᵣ₂ are complementary, second switches Tᵣ₅ and Tᵣ₄ are complementary, and second switches Tᵣ₅ and Tᵣ₆ are complementary.

The controller 110 may calculate the dead time t_{dead} of the inverter 105 for each switch of the first switches T₁-T₆. The controller 110 may calculate the dead time t_{dead} of the inverter 105 for a particular switch as a function of the resonant inductance Lᵣ, the resonant capacitance Cᵣ, a switch operating (e.g., on/off) time of the respective switch tswitch_trans, a temperature of the respective switch switch_temp, the input DC bus voltage V_{dc}, and/or the input inverter current I_{dc}. The controller may select resonant inductance values Lᵣ and resonant capacitance values Cᵣ that result in the calculated dead time being below a minimum threshold value.

For example, the controller 110 may calculate the dead time of inverter 105 using Equation 7. Considering the minimum transition time and delay of power switches, dead time t_{dead} of the inverter 105 should be larger than a minimum value as described in Equation 18 to reduce or prevent a possible shoot-through issue.

$${t}_{dead} > {t}_{dead\_min} \qquad \underline{Equation 18}$$

At S830, the controller 110 selects a resonant inductance value Lᵣ and/or a resonant capacitance value Cᵣ for the inductors Lᵣ₁-Lᵣ₃ and the second capacitors Cᵣ₁-Cᵣ₆. For example, the controller 110 may select resonant inductance values Lᵣ₁-Lᵣ₃ and resonant capacitance values Cᵣ₁-Cᵣ₃ that optimizes efficiency of the inverter 105 while also resulting in a maximum change of voltage over time dV/dt that is less than a voltage over time of the inverter 105 calculated according to hard switching and/or resulting in the calculated dead time t_{dead} being below the minimum threshold value. For example, the controller 110 may select a resonant inductance value Lᵣ and a resonant capacitance value Cᵣ that lead to the maximum efficiency with a lowest change in voltage over time dV/dt value for the inverter 105. For example, the controller 110 may select a resonant inductance value L, and a resonant capacitance value Cᵣ with a highest efficiency value of the inverter 105 that also satisfies the threshold voltage requirements and threshold dead time t_{dead} requirements discussed above.

Alternatively, the controller 110 may use a fixed value of resonant conductance Cᵣ (for example, the fixed resonant conductance Cᵣ value may be based on cost, size, 0.5CrVdc² loss incurred in the switch, etc.) and may vary only the resonant inductance Lᵣ values while observing soft-switch conditions occurring at a given operating point. Using a fixed resonant conductance Cᵣ value while varying the resonant inductance Lᵣ values will cause hard switching, but the controller 110 may operate the inverter 105 at a super low frequency (e.g., less than 4 kHz) during periods of hard switching, and raise the switching frequency (e.g., to greater than 40 kHz) when the soft-switching conditions are observed. This alternative may be feasible with less precision of design and selection of resonant inductance Lᵣ and resonant capacitance Cᵣ values and could widen an operating power range of the inverter 105.

The inverter 105 may be assembled with inductors Lᵣ₁-Lᵣ₃ having the selected resonant inductance value Lᵣ and with second capacitors Cᵣ₁-Cᵣ₆ having the selected resonant capacitance value Cᵣ.

According to some example embodiments, the inductors Lᵣ₁-Lᵣ₃ may be variable inductors. The controller 110 may perform the operations discussed with reference to FIG. 8 during implementation of the inverter. For example, the controller 110 may execute the method according to FIG. 8 during operation of the electro-mechanical system 152 and modify a value of the variable inductors Lᵣ₁-Lᵣ₃ according to the selected resonant inductance value Lᵣ to fit a desired power output for the inverter 105.

A method for optimizing an inverter for soft switching according to at least some example embodiments includes calculating efficiency values of the inverter based on a plurality of possible resonant inductance values and a plurality of possible resonant capacitance values, calculating change of voltage over time values of the inverter based on the plurality of possible resonant inductance values and the plurality of possible resonant capacitance values, and selecting a resonant inductance value of the plurality of possible resonant inductance values and a resonant capacitance value of the plurality of possible resonant capacitance values based on the calculated efficiency values of the inverter and the calculated change of voltage over time values.

In at least some example embodiments, the method includes calculating dead time values of the inverter based on the plurality of resonant inductance values and the plurality of resonant capacitance values.

In at least some example embodiments, the dead time values indicate a waiting time between two complementary switches.

In at least some example embodiments, the calculating the dead time values includes calculating the dead time values based on at least two of a possible resonant inductance value of the plurality of possible resonant inductance values, a possible resonant capacitance values, a switch operation time, a switch temperature, an input voltage, or an input current.

In at least some example embodiments, the selecting the resonant inductance values and the resonant capacitance values includes selecting a resonant inductance value of the plurality of possible resonant inductance values and a resonant capacitance value of the plurality of possible resonant capacitance values that satisfy a threshold dead time value.

In at least some example embodiments, the calculating the efficiency values of the inverter includes calculating the efficiency values according to a simulation model of the inverter.

In at least some example embodiments, the calculating the efficiency values of the inverter includes calculating the efficiency value of the inverter based on at least two of an inverter voltage, an inverter current, a switch voltage, a switch current, a switch turn-on time, a switch turn-off time, a switch die temperature, or a number of switches in the inverter.

In at least some example embodiments, the calculating the maximum change of voltage over time values includes calculating the maximum change of voltage over time of the inverter based on at least two of a switch-on voltage of a respective switch, a switch-off voltage of the respective switch, a turn-on time of the respective switch, or a turn-off time of the respective switch.

In at least some example embodiments, the selecting the resonant inductance values and the resonant capacitance values includes selecting a resonant inductance value of the plurality of possible resonant inductance values and a resonant capacitance value of the plurality of possible resonant capacitance values that lead to the highest efficiency value of the calculated efficiency values and the lowest change of voltage over time value of the calculated change of voltage over time values.

In at least some example embodiments, the inverter is an auxiliary resonant commutated pole (ARCP) inverter.

In at least some example embodiments, the inverter includes a plurality of first switches and a plurality of second switches, each first switch of the plurality of first switches including a respective resonant capacitor connected in parallel to the respective first switch.

In at least some example embodiments, the inverter includes a resonant inductor electrically connected between the plurality of first switches and the plurality of second switches.

In at least some example embodiments, the method further includes assembling the inverter to include the selected resonant inductance value and the selected resonant capacitance value.

In at least some example embodiments, the method further includes changing a value of a variable inductor of the inverter based on the selected resonant inductance value while the inverter operates.

An electric drive according to example embodiments includes an inverter and processing circuitry configured to cause the electric drive to calculate efficiency values of the inverter based on a plurality of possible resonant inductance values and a plurality of possible resonant capacitance values, calculate change of voltage over time values of the inverter based on the plurality of possible resonant inductance values and the plurality of possible resonant capacitance values, and select a resonant inductance value of the plurality of possible resonant inductance values and a resonant capacitance value of the plurality of possible resonant capacitance values based on the calculated efficiency values of the inverter and the calculated change of voltage over time values.

In at least some example embodiments, the processing circuitry is further configured to cause the electric drive to calculate dead time values of the inverter based on the plurality of possible resonant inductance values and the plurality of possible resonant capacitance values.

In at least some example embodiments, the dead time values indicate a waiting time between two complementary switches.

In at least some example embodiments, the processing circuitry is configured to cause the electric drive to calculate the dead time values based on at least two of a possible resonant inductance value of the plurality of possible resonant inductance values, a possible resonant capacitance value, a switch operation time, a switch temperature, an input voltage, or an input current.

In at least some example embodiments, the processing circuitry is further configured to cause the electric drive to select a resonant inductance value of the plurality of possible resonant inductance values and a resonant capacitance value of the plurality of possible resonant capacitance values that satisfy a threshold dead time value.

In at least some example embodiments, the processing circuitry is further configured to calculate the efficiency values according to a simulation model of the inverter.

In at least some example embodiments, the processing circuitry is further configured to calculate the efficiency value of the inverter based on at least two of an inverter voltage, an inverter current, a switch voltage, a switch current, a switch turn-on time, a switch turn-off time, a switch die temperature, or a number of switches in the inverter.

In at least some example embodiments, the processing circuitry is further configured to cause the electric drive to calculate the maximum change of voltage over time of the inverter based on at least two of a switch-on voltage of a respective switch, a switch-off voltage of the respective switch, a turn-on time of the respective switch, or a turn-off time of the respective switch.

In at least some example embodiments, the processing circuitry is further configured to cause the electric drive to select a resonant inductance value of the plurality of possible resonant inductance values and a resonant capacitance value of the plurality of possible resonant capacitance values that lead to the highest efficiency value of the calculated efficiency values and the lowest change of voltage over time value of the calculated change of voltage over time values.

In at least some example embodiments, the inverter is an auxiliary resonant commutated pole (ARCP) inverter.

In at least some example embodiments, the inverter includes a plurality of first switches and a plurality of second switches, each first switch of the plurality of first switches including a respective resonant capacitor connected in parallel to the respective first switch.

In at least some example embodiments, the inverter includes a resonant inductor electrically connected between the plurality of first switches and the plurality of second switches.

In at least some example embodiments, the processing circuitry is further configured to cause the electric drive to change a value of a variable inductor of the inverter based on the selected resonant inductance value while the inverter operates.

An inverter according to example embodiments includes a plurality of inductors having a resonant inductance value, and a plurality of capacitors having a resonant capacitance value, wherein the resonant inductance value and the resonant capacitance value are based on calculated efficiency values of the inverter and calculated change of voltage over time values of the inverter, wherein the calculated efficiency values of the inverter are based on a plurality of possible resonant inductance values and a plurality of possible resonant capacitance values, and wherein the calculated change of voltage over time values of the inverter are based on the plurality of possible resonant inductance values and the plurality of possible resonant capacitance values.

At least one example embodiment provides a non-transitory computer readable storage medium storing computer executable instructions that, when executed, cause a device to perform a method for optimizing an inverter for soft switching, the method including calculating efficiency values of the inverter based on a plurality of possible resonant inductance values and a plurality of possible resonant capacitance values, calculating change of voltage over time values of the inverter based on the plurality of possible resonant inductance values and the plurality of possible resonant capacitance values, and selecting a resonant inductance value of the plurality of possible resonant inductance values and a resonant capacitance value of the plurality of possible resonant capacitance values based on the calculated efficiency values of the inverter and the calculated change of voltage over time values.

At least one example embodiment provides a device for optimizing an inverter for soft switching, the device including a means for calculating efficiency values of the inverter based on a plurality of possible resonant inductance values and a plurality of possible resonant capacitance values, a means for calculating change of voltage over time values of the inverter based on the plurality of possible resonant inductance values and the plurality of possible resonant capacitance values, and a means for selecting a resonant inductance value of the plurality of possible resonant inductance values and a resonant capacitance value of the plurality of possible resonant capacitance values based on the calculated efficiency values of the inverter and the calculated change of voltage over time values.

G. Tabrizi, F. Schnabel and M. Jung, “Optimized Design Method and Control of an Auxiliary Resonant Commutated Pole Inverter for Two Level Photovoltaic Inverters,” PCIM Europe digital days 2021; International Exhibition and Conference for Power Electronics, Intelligent Motion, Renewable Energy and Energy Management, Online, 2021, pp. 1-8 and A. Charalambous, X. Yuan and N. McNeill, “High-Frequency EMI Attenuation at Source With the Auxiliary Commutated Pole Inverter,” in IEEE Transactions on Power Electronics, vol. 33, no. 7, pp. 5660-5676 Jul. 2018 discuss parameter optimization in soft switching inverters, the contents of each of with are herein incorporated by reference in their entireties.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method for optimizing an inverter for soft switching, the method comprising:
calculating efficiency values of the inverter based on a plurality of possible resonant inductance values and a plurality of possible resonant capacitance values;
calculating change of voltage over time values of the inverter based on the plurality of possible resonant inductance values and the plurality of possible resonant capacitance values; and
selecting a resonant inductance value of the plurality of possible resonant inductance values and a resonant capacitance value of the plurality of possible resonant capacitance values based on the calculated efficiency values of the inverter and the calculated change of voltage over time values.

2. The method of claim 1, further comprising:
calculating dead time values of the inverter based on the plurality of possible resonant inductance values and the plurality of possible resonant capacitance values.

3. The method of claim 2, wherein the dead time values indicate a waiting time between two complementary switches.

4. The method of claim 2, wherein the calculating the dead time values includes calculating the dead time values based on at least two of a possible resonant inductance value of the plurality of possible resonant inductance values, a possible resonant capacitance value, a switch operation time, a switch temperature, an input voltage, or an input current.

5. The method of claim 2, wherein the selecting the resonant inductance values and the resonant capacitance values includes selecting a resonant inductance value of the plurality of possible resonant inductance values and a resonant capacitance value of the plurality of possible resonant capacitance values that satisfy a threshold dead time value.

6. The method of claim 1, wherein the calculating the efficiency values of the inverter includes calculating the efficiency values according to a simulation model of the inverter.

7. The method of claim 1, wherein the calculating the efficiency values of the inverter includes calculating the efficiency value of the inverter based on at least two of an inverter voltage, an inverter current, a switch voltage, a switch current, a switch turn-on time, a switch turn-off time, a switch die temperature, or a number of switches in the inverter.

8. The method of claim 1, wherein the calculating the change of voltage over time values includes calculating a maximum change of voltage over time of the inverter based on at least two of a switch-on voltage of a respective switch, a switch-off voltage of the respective switch, a turn-on time of the respective switch, or a turn-off time of the respective switch.

9. The method of claim 1, wherein the selecting the resonant inductance values and the resonant capacitance values includes selecting a resonant inductance value of the plurality of possible resonant inductance values and a resonant capacitance value of the plurality of possible resonant capacitance values that lead to a highest efficiency value of the calculated efficiency values and a lowest change of voltage over time value of the calculated change of voltage over time values.

10. The method of claim 1, wherein the inverter is an auxiliary resonant commutated pole (ARCP) inverter.

11. The method of claim 1, wherein the inverter includes a plurality of first switches and a plurality of second switches, each first switch of the plurality of first switches including a respective resonant capacitor connected in parallel to the respective first switch.

12. The method of claim 11, wherein the inverter includes a resonant inductor electrically connected between the plurality of first switches and the plurality of second switches.

13. The method of claim 1, further comprising:
assembling the inverter to include the selected resonant inductance value and the selected resonant capacitance value.

14. The method of claim 1, further comprising:
changing a value of a variable inductor of the inverter based on the selected resonant inductance value while the inverter operates.

15. An electric drive comprising:
an inverter; and
processing circuitry configured to cause the electric drive to
calculate efficiency values of the inverter based on a plurality of possible resonant inductance values and a plurality of possible resonant capacitance values,
calculate change of voltage over time values of the inverter based on the plurality of possible resonant inductance values and the plurality of possible resonant capacitance values, and
select a resonant inductance value of the plurality of possible resonant inductance values and a resonant capacitance value of the plurality of possible resonant capacitance values based on the calculated efficiency values of the inverter and the calculated change of voltage over time values.

16. The electric drive of claim 15, wherein the processing circuitry is further configured to cause the electric drive to calculate dead time values of the inverter based on the plurality of possible resonant inductance values and the plurality of possible resonant capacitance values.

17. The electric drive of claim 16, wherein the dead time values indicate a waiting time between two complementary switches.

18. The electric drive of claim 16, wherein the processing circuitry is configured to cause the electric drive to calculate the dead time values based on at least two of a possible resonant inductance value of the plurality of possible resonant inductance values, a possible resonant capacitance value, a switch operation time, a switch temperature, an input voltage, or an input current.

19. The electric drive of claim 16, wherein the processing circuitry is further configured to cause the electric drive to select a resonant inductance value of the plurality of possible resonant inductance values and a resonant capacitance value of the plurality of possible resonant capacitance values that satisfy a threshold dead time value.

20. The electric drive of claim 15, wherein the processing circuitry is further configured to calculate the efficiency values according to a simulation model of the inverter.

21. The electric drive of claim 15, wherein the processing circuitry is further configured to calculate the efficiency values of the inverter based on at least two of an inverter voltage, an inverter current, a switch voltage, a switch current, a switch turn-on time, a switch turn-off time, a switch die temperature, or a number of switches in the inverter.

22. The electric drive of claim 15, wherein the processing circuitry is further configured to cause the electric drive to calculate a maximum change of voltage over time of the inverter based on at least two of a switch-on voltage of a respective switch, a switch-off voltage of the respective switch, a turn-on time of the respective switch, or a turn-off time of the respective switch.

23. The electric drive of claim 15, wherein the processing circuitry is further configured to cause the electric drive to select a resonant inductance value of the plurality of possible resonant inductance values and a resonant capacitance value of the plurality of possible resonant capacitance values that lead to a highest efficiency value of the calculated efficiency values and a lowest change of voltage over time value of the calculated change of voltage over time values.

24. The electric drive of claim 15, wherein the inverter is an auxiliary resonant commutated pole (ARCP) inverter.

25. The electric drive of claim 15, wherein the inverter includes a plurality of first switches and a plurality of second switches, each first switch of the plurality of first switches including a respective resonant capacitor connected in parallel to the respective first switch.

26. The electric drive of claim 25, wherein the inverter includes a resonant inductor electrically connected between the plurality of first switches and the plurality of second switches.

27. The electric drive of claim 15, wherein the processing circuitry is further configured to cause the electric drive to change a value of a variable inductor of the inverter based on the selected resonant inductance value while the inverter operates.

28. An inverter comprising:
a plurality of inductors having a resonant inductance value; and
a plurality of capacitors having a resonant capacitance value,
wherein the resonant inductance value and the resonant capacitance value are based on calculated efficiency values of the inverter and calculated change of voltage over time values of the inverter,
wherein the calculated efficiency values of the inverter are based on a plurality of possible resonant inductance values and a plurality of possible resonant capacitance values, and
wherein the calculated change of voltage over time values of the inverter are based on the plurality of possible resonant inductance values and the plurality of possible resonant capacitance values.
